(19) United States
(12) Patent Application Publication
(10) Pub. No.: US 2024/0315211 A1
(43) Pub. Date: Sep. 26, 2024

(54) SYSTEM AND METHOD FOR ADAPTIVE ANIMAL MONITORING

(71) Applicant: Wandering Shepherd Technology Ltd., Alberta (CA)

(72) Inventors: Neil Charles Helfrich, Alberta (CA); Sheldon Troy Charles Archibald, Alberta (CA)

(21) Appl. No.: 18/675,086

(22) Filed: May 27, 2024

(51) Int. Cl. A01K 29/00; A01K 11/00; A61D 13/00; A61D 99/00

(52) U.S. Cl. CPC A01K 29/005; A01K 11/007; A61D 13/00; A61D 99/00

(57) ABSTRACT

A system and method for animal monitoring is disclosed. The system comprises a bolus communicatively coupled to a plurality of wireless transponder and a wireless network with a base station in communication with the plurality of wireless transponder. The bolus comprises of a plurality of sensor to measure animal characteristic at a pre-configured sampling/polling rate, a processing unit, a memory unit, a clock unit, a transceiver unit and a plurality of antenna unit. The method comprises at least one of the plurality of sensor detecting/identifying a variation in animal characteristic. The processing unit using the memory unit and the real time clock unit is configured to change the corresponding pre-configured sampling/polling rate of the at least one of the plurality of sensor automatically depending on rate of variation in the animal characteristic. The transceiver unit is configured to communicate the automatic changes in pre-configured sampling/polling rate to the plurality of wireless transponder.

### FIELD OF THE INVENTION

This disclosure relates generally to a system and method for monitoring one or more animal characteristics and, in particular, to adaptive animal monitoring.

### BACKGROUND OF THE INVENTION

As the population across the globe increases with more mouths to feed increasing exponentially every second, the need for monitoring the health status of livestock in general is increasing in order to increase the production of livestock to in particular to provide healthier livestock. In order to achieve the stated objective prior attempts to monitor the characteristics of livestock and detect the health status of livestock, health sensor devices have been attached and disposed to and within the body of each animal, and the resulting biometric data of the animal obtained from the health sensor devices analyzed and provided.

US 20090182207A1 discloses an ingestible bolus configured to be maintained in a stomach of an animal. Ballast weight and a power source may be disposed therein. The ballast weight may be configured to cause the bolus to be maintained in contact with a stomach wall of the animal when disposed therein. The bolus may comprise sensors to measure one or more animal characteristics, a transmitter in wireless communication with an animal monitoring system, a memory unit to store measured characteristics and bolus configuration data, and processor to control the operation of the bolus components. The transmitter may be in communication with an antenna. The antenna may be separated from the sensors, processors, and transmitter to prevent and/or reduce interference and/or coupling there between. The sensors are programmed to sample/poll to measure the corresponding animal characteristics of respective animal of livestock at a preset sampling/polling rate and update using wireless communication.

US 20090187392A1 provides an ingestible bolus may be disposed within the stomach of an animal. The bolus may comprise one or more sensors to monitor one or more internal and/or external animal characteristics. The bolus may comprise a data transmitter in wireless communication with a base station. The base station may receive messages from the bolus comprising one or more measured animal characteristics. The base station may comprise a process to monitor the animal and/or be in communication with a process to monitor the animal. The process limits to building an animal profile based upon the observed characteristics of the animal without taking into consideration real time variation in animal characteristic, the characteristics of other animals in a group associated with the animal, and/or characteristics associated with the breed and/or sex of the animal. Based on this profile, the process may detect a change in a health condition of the animal. Such heath conditions may include, but are not limited to, an estrus condition in the animal, off-feed condition, a nominal condition, the animal leaving an enclosure, or the like.

WO2022220317A1 discloses an ingestible health sensor device configured to stay in the stomach of an animal may be formed of a substantially cylindrical housing shell. A ballast weight and a power source may be disposed therein. The ballast weight may be configured to cause the health sensor device to remain in contact with the gastric wall of the animal when the health sensor device is disposed in the animal's stomach. The health sensor device may comprise: a sensor which measures a plurality of animal characteristics; a transmitter which wirelessly communicates with an animal monitoring system; a memory unit for storing the measured characteristics and health sensor device configuration data; and a processor which controls the operation of the components of the health sensor device. The transmitter may communicate with an antenna, and the antenna may be formed as a trace on an antenna circuit board such as a printed circuit board (PCB). The antenna may be separated from the sensor, the processor, and the transmitter to prevent and/or reduce interference and/or coupling there between. The invention is restricted by the limitations of the method and system by the disclosure for measuring only the digestibility in the rumen of a ruminant of the animal by withdrawing gastric juices from various locations in the rumen.

Prior attempts at animal monitoring systems and methods involved multiple constraints, often related to particular animal anatomy, analysis based on statutory animal profiling.

Accordingly, in view of the above-mentioned drawbacks, there is a need for an improved method and system for animal monitoring.

### SUMMARY OF THE INVENTION

To address the foregoing problems, in whole or in part, and/or other problems that may have been observed by persons skilled in the art, the present disclosure provides compositions and methods as described by way of example as set forth below.

A system for real-time animal monitoring comprises of an ingestible bolus disposable within a stomach of the animal of livestock to measure one or more characteristics of the animal. The ingestible the bolus further comprises of a plurality of sensor to measure animal characteristic at a pre-configured sampling/polling rate, a processing unit communicatively coupled to the plurality of sensor, a memory unit communicatively coupled to the processing unit, a real time clock unit, a transceiver unit communicatively coupled to the processing unit, a plurality of antenna unit communicatively coupled to the transceiver unit, a plurality of wireless transponder communicatively coupled to the bolus and a wireless network with a base station in communication with the plurality of wireless transponder. One of the plurality of sensor detects/identifies a variation in corresponding animal characteristic of respective animal. The processing unit using the memory unit and the real time clock unit is configured to change the corresponding pre-configured sampling/polling rate of the respective one of the plurality of sensor automatically depending on rate of variation in the corresponding animal characteristic of the respective animal. The transceiver unit configured to communicate the automatic changes in pre-configured sampling/polling rate of the corresponding one of the plurality of sensor in real-time using the plurality of antenna to the plurality of wireless transponder.

The plurality of wireless transponder is configured to communicatively update the variation in corresponding animal characteristic of the respective animal based on the changes in pre-configured sampling/polling rate to the wireless network and the base station in real-time. The plurality of wireless transponder is further configured to communicatively update the variation in corresponding animal characteristic of the respective animal to an extra-terrestrial network. The base station on receiving the variation in the corresponding animal characteristic of the respective animal, is further configured to determine the vicinity of the respective animal amongst the livestock using one or more of the plurality wireless transponder and the wireless network enabling an adaptive animal monitoring.

A principal object of the invention is to provide a method for real-time animal monitoring comprising magnetizing a ingestible bolus to turn-on the bolus, disposing the ingestible bolus within a stomach of the animal of livestock, measuring one or more characteristics of the animal using a plurality of sensor. The method further comprises of detecting/identifying a variation in corresponding animal characteristic of respective animal and changing of the corresponding pre-configured sampling/polling rate of the respective at least one of the plurality of sensor automatically depending on rate of variation in the corresponding animal characteristic of the respective animal. The method further comprises of communicating the automatic changes in pre-configured sampling/polling rate of the corresponding at least one of the plurality of sensor in real-time and updating the variation in corresponding animal characteristic of the respective animal based on the changes in pre-configured sampling/polling rate to the wireless network and the base station in real-time. The plurality of wireless transponder is further configured to communicatively update the variation in corresponding animal characteristic of the respective animal to an extra-terrestrial network. The next step in the method comprises of processing by the base station on receiving the variation in the corresponding animal characteristic of the respective animal for determining the vicinity of the respective animal amongst the livestock enabling an adaptive animal monitoring.

Additional features of the invention will be or will become apparent to one with skill in the art upon examination of the following figures and detailed description. It is intended that all such additional features and advantages be included within this description, be within the scope of the invention, and be protected by the accompanying claims.

### BRIEF DESCRIPTION OF THE DRAWINGS

Having thus described the subject matter of the present invention in general terms, reference will now be made to the accompanying drawings, which are not necessarily drawn to scale, and wherein:

FIG. 1 illustrates an embodiment of a system for adaptive monitoring of an animal;

FIG. 2 illustrates an embodiment of a method flowchart for adaptive monitoring of the animal employing an ingestible bolus as illustrated in FIG. 1;

FIG. 3 illustrates a screen shot of a software system for determining vicinity of an animal amongst livestock in accordance with an embodiment of as system for adaptive monitoring of an animal amongst the livestock.

Skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF THE INVENTION

The subject matter of the present invention now will be described more fully hereinafter with reference to the accompanying drawings, in which some, but not all embodiments of the subject matter of the present invention are shown. Like numbers refer to like elements throughout. The subject matter of the present invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the present invention pertains having the benefit of the teachings presented in the foregoing descriptions and the associated drawings. All illustrations of the drawings are for the purpose of describing selected versions of the present invention and are not intended to limit the scope of the present invention. Therefore, it is to be understood that the subject matter of the present invention is not to be limited to the specific embodiments disclosed and that modifications and other embodiments are intended to be included within the scope of the appended claims.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and example of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one”, but does not exclude a plurality unless the contextual use dictates otherwise. When used herein to join a list of items, “or” denotes “at least one of the items”, but does not exclude a plurality of items of the list. Finally, when used herein to join a list of items, “and” denotes “all of the items of the list”.

This disclosure relates generally to systems and methods for monitoring a health condition of an animal and, in particular, to systems and methods for monitoring one or more animal characteristics to detect a health condition of the animal.

It will be readily understood that the components of the present invention, as generally described and illustrated in the Figures herein, could be arranged and designed in a wide variety of different configurations. Thus, the following detailed description of the embodiments of the apparatus, system, and method of the disclosure is not intended to limit the scope of the disclosure, as claimed, but is merely representative of possible embodiments of the disclosure. In some cases, well-known structures, materials, or operations are not shown or described in detail. Furthermore, the described features, structures, or characteristics may be combined in any suitable manner in one or more embodiments. It will also be readily understood that the components of the embodiments as generally described and illustrated in the Figures herein could be arranged and designed in a wide variety of different configurations.

The order of the steps or actions of the methods described in connection with the embodiments disclosed may be changed as would be apparent to those skilled in the art. Thus, any order in the Figures or description is for illustrative purposes only and is not meant to imply a required order, unless specified to require an order.

Certain aspects of the embodiments described may be illustrated as hardware components, or software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that perform one or more tasks or implements particular abstract data types. In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

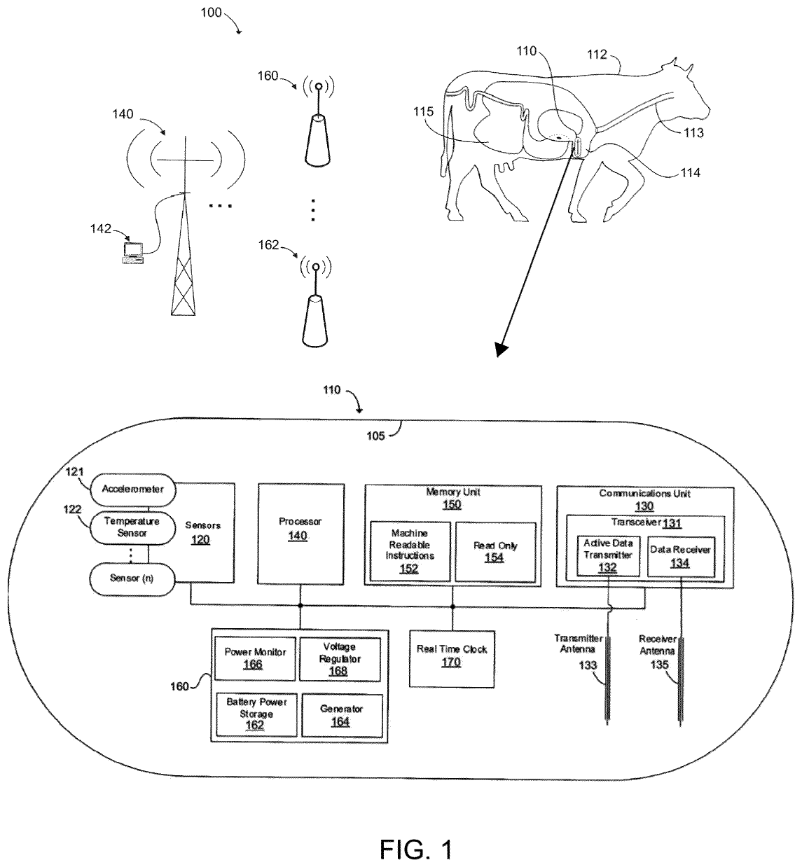

Turning now to FIG. 1, a block diagram 100 of one embodiment of a system for monitoring one or more animal characteristics is depicted. In FIG. 1, A system for real-time animal monitoring is disclosed, the animal monitoring system comprises of an ingestible bolus 110 disposable within a stomach 114 of the animal 112 of livestock to measure one or more characteristics of the animal 112, the ingestible bolus 110 further comprises of a plurality of sensor 120 to measure characteristic of the animal at a pre-configured sampling/polling rate, a processing unit 140 communicatively coupled to the plurality of sensor 120, a memory unit 150 communicatively coupled to the processing unit 140, a real time clock unit 170, a transceiver unit 131 communicatively coupled to the processing unit 140, a plurality of antenna unit 133, 135 communicatively coupled to the transceiver unit 131, a plurality of wireless transponder 160, 162 communicatively coupled to the ingestible bolus 110 and a wireless network 140 with a base station 142 in communication with the plurality of wireless transponder 160, 162.

At least one 122 of the plurality of sensor 120 detects/identifies a variation in corresponding animal characteristic of respective animal 112 whereupon the processing unit 140 using the memory unit 150 and the real time clock unit 170 is configured to change the corresponding pre-configured sampling/polling rate of the respective at least one 122 of the plurality of sensor 120 automatically depending on rate of variation in the corresponding animal characteristic of the respective animal 112. The transceiver unit 131 is configured to communicate the automatic changes in pre-configured sampling/polling rate of the corresponding at least one 122 of the plurality of sensor 120 in real-time using the plurality of antenna 133, 135 to the plurality of wireless transponder 160, 162. The plurality of wireless transponder 160, 162 is further configured to communicatively update the variation in corresponding animal characteristic of the respective animal 112 based on the changes in pre-configured sampling/polling rate to the wireless network 140 and the base station 142. The plurality of wireless transponder is further configured to communicatively update the variation in corresponding animal characteristic of the respective animal based on the changes in pre-configured sampling/polling rate to an extra-terrestrial network.

The base station 142 on receiving the variation in the corresponding animal characteristic of the respective animal 112 is further configured to determine the vicinity of the respective animal 112 amongst the livestock using one or more of the plurality wireless transponder 160, 162 and the wireless network 140. The base station 142 is further configured by using the wireless network 140 and the one or more of the plurality of wireless transponder 160, 162, to update the ingestible bolus 110 wireless transmission of machine executable set of sequential instructions to the ingestible bolus 110 enabling an adaptive animal monitoring.

In an embodiment of the present disclosure as depicted in FIG. 1 an ingestible bolus 110 may be disposed within the body of an animal 112. The ingestible bolus 110 may be configured to be ingested via the esophagus 113 of a ruminant animal, such as a bovine. In this embodiment, the ingestible bolus 110 may be configured to have a size and density which will enable it to remain within the stomach of a bovine, ensuring that it is not regurgitated from the animal's reticulum 115 and/or rumen 114.

FIG. 1 shows ingestible bolus 110 within rumen 114 of ruminant animal. The ingestible bolus 110 may be maintained in any stomach and/or stomach chamber capable of holding the ingestible bolus 110. The ingestible bolus 110 may be capable of remaining in the animal's reticulum 115 and/or rumen 114 throughout the life of the animal.

In an alternative embodiment, a bolus may be injected into and/or implanted under the skin of an animal or otherwise implanted within the body of an animal.

The ingestible bolus 110 may comprise a plurality of sensors 120 to detect one or more characteristics of animal 112. In this embodiment, the ingestible bolus 110 may wirelessly transmit data corresponding to monitored animal characteristics to base station 142. Monitored animal characteristics may include physiological characteristics, such as animal temperature, stomach pH, blood pH, heart rate, respiration, stomach contractions, and the like. Monitored animal characteristics may also include non-physiological characteristics, such as animal movement and/or motion activity, animal location, and the like.

Base station 142 may comprise a computing device communicatively coupled to base station 142. Computing device may be any general and/or specific purpose computing device known in the art.

The wireless communication means of ingestible bolus 110 may comprise a wireless transmitter and/or receiver operating at 900 MHz or some other suitable radio frequency (RF). In some embodiments, such wireless communication may be two-way, allowing the ingestible bolus 110 to transmit and receive data from the base station 142. In other embodiments, bolus may only be capable of transmitting data to the base station 142.

Animals in livestock may be capable of roaming over a relatively large area, such as a feed lot, dairy, range area, enclosure, or the like. As such, the distance between the base station 142 and the ingestible bolus 110 may become greater than the wireless communication range of the ingestible bolus 110. In this case, the plurality of wireless transponder 160, 162 may be deployed to increase the communications range of the ingestible bolus 110 to the base station 142. The plurality of transponder 160, 162 may receive wireless transmissions from the ingestible bolus 110 and retransmit them at a higher power and/or a different frequency to allow such transmissions to be received by the base station 142. Similarly, in this embodiment, the plurality of transponder 160, 162 may receive transmissions from the base station 142 to ingestible bolus 110 and retransmit them at higher power so that they may be received by the ingestible bolus 110.

The wireless communication characteristics of the ingestible bolus 110 between the base station 142 and/or the plurality of transponder 160, 162 may allow the base station 142 to determine location information relating to the respective animal 112. In an embodiment employing only a single base station 142, the base station 142 may be configured to determine the animal's distance from the base station 142. This may be done in a variety of ways including, but not limited to: determining distance based upon wireless signal strength; determining distance from timestamp information in the wireless message: or the like.

As shown in FIG. 1, the system may comprise the base station 142 and/or the plurality of transponder 160, 162. In this case, the base station 142 may determine location information relating to animal using well-known wireless communications triangulation methods.

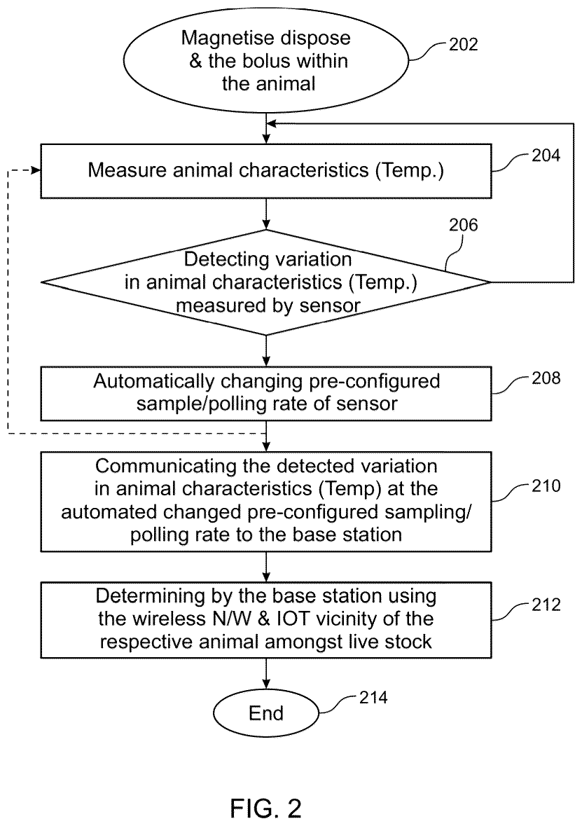

FIG. 2 illustrates an embodiment of a process flowchart 200 for adaptive monitoring of the animal employing an ingestible bolus as illustrated in FIG. 1. The first step at 202 starts with magnetizing and disposing the ingestible bolus within the animal as illustrated & described in FIG. 1. The next step at 204 comprises measuring a corresponding characteristic of the animal of livestock using at least one of a plurality of sensor located within the ingestible bolus of the respective animal. Moving on to step 206 if the at least one of a plurality of sensor detects/identifies a variation in the measured animal characteristic outside the preset characteristic range. In an exemplary scenario, the measured animal characteristic correspond to temperature of the animal, increase or decrease in the temperature is detected/identified by the corresponding at least one of the plurality of sensor configured as a temperature sensing sensor, the measurement is recorded and the process either moves to a next step 208 or if the measured temperature is found to be within the preset temperature range (indicative of normal physiological state of the corresponding animal amongst the livestock) the process loops back to step 204 to again measure the temperature of the corresponding animal at a pre-configured sampling/polling rate. If the temperature sensor corresponding to the at least one of the plurality of sensor detects/identifies a variation (increase/decrease) at step 206 the process moves to the next step at 208 comprising of automatically changing the pre-configured sampling/polling rate of the at least one of the plurality of sensor to indicate the temperature variation. After the automated change in pre-configured sampling/polling rate, the process moves to the next step 210 and also the process simultaneously waits at the changed pre-configured sample/polling rate to measure a new sample of animal characteristic at 204. The next step at 210 comprises of communicating the detected/identified temperature variation at the changed pre-configured sampling/polling rate to the base station 142 using the Internet of Things (IoT) enabled devices corresponding to the at least one of the plurality of wireless transponder 160, 162 and the wireless network 140. The process moves to the next step at 212 where the base station 142 using the wireless network 140 and the Internet of Things (IoT) enabled devices 160, 162 determines the vicinity of the respective animal amongst the livestock.

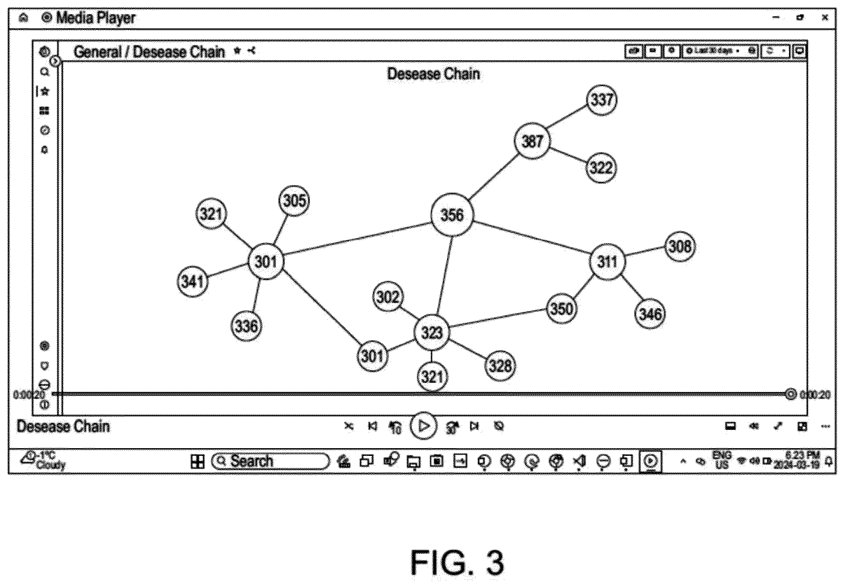

FIG. 3 depicts a screen shot of a software system 300 for determining vicinity of an animal 301 amongst livestock (302, 311, 320, 321 . . . ) in accordance with an embodiment of a system and method for adaptive monitoring of an animal amongst the livestock (302, 311, 320, 321 . . . ).

The base station 142 and/or computing device may be monitored by and/or in communication with an animal manager. The animal manager may refer to any person, machine, and/or process used to manage one or more animals. The animal manager may be in charge of and/or responsible for one or more animals monitored by the systems and methods disclosed herein. An animal manager may comprise one or more automated systems, such as feeding, heating, cooling and other systems. An animal manager may further comprise a human animal manager and/or veterinarian. The base station 142 and/or computing system may be configured by and/or interact with the animal manager to monitor and/or respond to changes in animal health condition.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art. Although the foregoing subject matter has been described in some detail by way of illustration and example for purposes of clarity of understanding, it will be understood by those skilled in the art that certain changes and modifications can be practiced within the scope of the appended claims.

What is claimed is:

1. A system for real-time animal monitoring comprising:
an ingestible bolus disposable within a stomach of the animal of livestock to measure one or more characteristics of the animal, the bolus further comprising:
a plurality of sensor to measure animal characteristic at a pre-configured sampling/polling rate,
a processing unit communicatively coupled to the plurality of sensor,
a memory unit communicatively coupled to the processing unit,
a real time clock unit,
a transceiver unit communicatively coupled to the processing unit,
a plurality of antenna unit communicatively coupled to the transceiver unit,
a plurality of wireless transponder communicatively coupled to the bolus; and
a wireless network with a base station in communication with the plurality of wireless transponder;
wherein at least one of the plurality of sensor detects/identifies a variation in corresponding animal characteristic of respective animal, the processing unit using the memory unit and the real time clock unit is configured to change the corresponding pre-configured sampling/polling rate of the respective at least one of the plurality of sensor automatically depending on rate of variation in the corresponding animal characteristic of the respective animal, the transceiver unit configured to communicate the automatic changes in pre-configured sampling/polling rate of the corresponding at least one of the plurality of sensor in real-time using the plurality of antenna to the plurality of wireless transponder, the plurality of wireless transponder is configured to communicatively update the variation in corresponding animal characteristic of the respective animal to the wireless network and the base station in real-time, the plurality of wireless transponder is further configured to communicatively update the variation in corresponding animal characteristic of the respective animal to an extra-terrestrial network, the base station on receiving the variation in the corresponding animal characteristic of the respective animal, is further configured to determine the vicinity of the respective animal amongst the livestock using one or more of the plurality wireless transponder and the wireless network, the base station using the wireless network and the one or more of the plurality of wireless transponder updates the ingestible bolus enabling an adaptive animal monitoring.

2. The system for real-time animal monitoring as claimed in claim 1, wherein the variation in corresponding animal characteristic of respective animal correspond to a preset range.

3. The system for real-time animal monitoring as claimed in claim 1, wherein the plurality of sensor to measure animal characteristic at a pre-configured sampling/polling rate correspond to a preset polling/sampling rate.

4. The system for real-time animal monitoring as claimed in claim 1, wherein the at least one of the plurality of sensor is configured to detect/identify the corresponding animal characteristic of the respective animal correspond to a temperature sensing sensor.

5. The system for real-time animal monitoring as claimed in claim 1, wherein the variation in the corresponding animal characteristic of the respective animal corresponds to a change in the physiological characteristic of the respective animal.

6. The system for real-time animal monitoring as claimed in claim 1, wherein the processing unit using the memory unit and the real time clock unit configured to automatically change the pre-configured sampling/polling rate of the corresponding at least one of the plurality of sensor corresponds to execution of a set of sequential computation instructions in the memory unit by the processor unit.

7. The system for real-time animal monitoring as claimed in claim 1, wherein the rate of variation in the corresponding animal characteristic of the respective animal corresponds to a preset range of variation.

8. The system for real-time animal monitoring as claimed in claim 1, wherein the ingestible bolus corresponds to a magnetized bolus.

9. The system for real-time animal monitoring as claimed in claim 1, wherein the transceiver unit corresponds to a combination of a transmitter and receiver.

10. The system for real-time animal monitoring as claimed in claim 1, wherein the plurality of wireless transponder correspond to Internet-of-Things (IoT) devices.

11. The system for real-time animal monitoring as claimed in claim 1, wherein the wireless network and the base station correspond to a Radio Frequency (RF) enabled network.

12. The system for real-time animal monitoring as claimed in claim 1, wherein the ingestible bolus disposed within the respective animal is powered by a power unit.

13. The system for real-time animal monitoring as claimed in claim 12, wherein the ingestible bolus disposed within the respective animal powered by the power unit comprises an in-built battery.

14. The system for real-time animal monitoring as claimed in claim 12, wherein the ingestible bolus disposed within the respective animal powered by the power unit corresponds to wireless charging.

15. The system for real-time animal monitoring as claimed in claim 1, wherein the base station using the wireless network and the one or more of the plurality of wireless transponder updating the ingestible bolus corresponds to wireless transmission of machine executable set of sequential instructions to the ingestible bolus.

16. The system for real-time animal monitoring as claimed in claim 1, wherein the plurality of wireless transponder further configured to communicatively update the variation in corresponding animal characteristic of the respective animal to an extra-terrestrial network corresponds to a communicatively coupled satellite network.

17. The system for real-time animal monitoring as claimed in claim 12, wherein the power unit comprises of a voltage regulator and a plurality of power modulation circuitry.

18. A method for real-time animal monitoring comprising:
magnetising an ingestible bolus to turn on the bolus;
disposing the ingestible bolus within a stomach of the animal of livestock;
measuring one or more characteristics of the animal using a plurality of sensor;
detecting/identifying a variation in corresponding animal characteristic of respective animal;
changing the corresponding pre-configured sampling/polling rate of the respective at least one of the plurality of sensor automatically depending on rate of variation in the corresponding animal characteristic of the respective animal;
communicating the automatic changes in pre-configured sampling/polling rate of the corresponding at least one of the plurality of sensor in real-time;
updating the variation in corresponding animal characteristic of the respective animal based on the changes in pre-configured sampling/polling rate to the wireless network and the base station in real-time;
updating the variation in corresponding animal characteristic of the respective animal to an extra-terrestrial network in real-time;
processing by the base station on receiving the variation in the corresponding animal characteristic of the respective animal for determining the vicinity of the respective animal amongst the livestock;
wirelessly transmitting by the base station using the wireless network and the one or more of the plurality of wireless transponder for updating the ingestible bolus with machine executable set of sequential instructions to the ingestible bolus enabling the method for adaptive animal monitoring.

19. The method for real-time animal monitoring as claimed in claim 18, wherein communicating the automatic changes in pre-configured sampling/polling rate of the corresponding at least one of the plurality of sensor in real-time uses the plurality of antenna communicatively coupled to the plurality of wireless transponder.

20. The method for real-time animal monitoring as claimed in claim 18, wherein the rate of variation detected/identified is inversely proportional to the pre-configured sampling/polling rate for the respective animal.
